(19) United States
(12) Patent Application Publication
(10) Pub. No.: US 2002/0171039 A1
(43) Pub. Date: Nov. 21, 2002

(54) Cloud content presentation system

(76) Inventor: Asher Bennett, Haifa (IL)

Correspondence Address: DR MARK FRIEDMAN LTD, c/o Bill Polkinghorn-Discovery Dispatch, 9003 Florin Way, Upper Marlboro, MD, 20772, US

(21) Appl. No.: 09/855,582

(22) Filed: May 16, 2001

(51) Int. Cl. G01N 15/06

(52) U.S. Cl. 250/330; 250/573

(57) ABSTRACT

A system and method for advertising and content presentation in the sky. An artificial cloud is created by an aircraft, which adds water vapor and particles to the atmosphere and color if desired. The artificial cloud or alternately, a natural cloud is used as a background for delivering a visual image. This can be achieved by projecting an image onto the cloud by either laser or visible light sources. Projection of the image is preferably performed from an aircraft. The artificial cloud or alternately, a natural cloud can be used as a base for cutting the cloud into the shape of the image, which is performed by dissipating the cloud from an aircraft, or alternately an image shape can be cut out of the cloud. This method can be exploited for clearing clouds in places such as above an airport in order to increase navigational visibility.

### FIELD AND BACKGROUND OF THE INVENTION

The present invention relates to the field of aerial advertising and content presentation and, more particularly, to system and method for advertising in the sky. The advertising is by forming a cloud in the sky or by using a cloud present in the sky and beaming an advertisement or content presentation onto or alternatively through the cloud. The present invention also describes dissipating a cloud, artificial or natural, using radiant energy.

Advertising in the sky or sky writing is a well-known phenomenon. Sky writing is an art that has been known for many years, and continues to find much popularity in advertising and publicity campaigns. Traditionally, the art comprises two basic forms of writing performed by two different methods, the first and most common method being that a highly skilled flyer in a plane equipped to dispense fog material behind it will literally maneuver his airplane acrobatically to form letters and words in script fashion, the plane essentially acting much like a pencil does on paper.

The second basic form of sky writing, now becoming particularly popular, is sky typing, in which individual, highly recognizable letters form words in the sky. This method involves precision flying by a team of usually five fog emitting planes flying together in formation to form letters and characters of block configuration similar to the characters printed by a typewriter. Each member of the team flies a specific course and direction parallel to one another and emits fog in proper position on a 5×5 matrix to form one horizontal part or leg of a letter. His companions, doing their part of the assignment, each forms another horizontal part or leg, and so forth until the letter is completed. Then, the next letter is formed, and on until the word or phrase is completed. Each plane will complete the appropriate legs of successive letters in similar fashion. Therefore a plurality of planes are required to form each letter of each word to be written. Several prior art patents deal with aerial advertising.

U.S. Pat. No. 3,990,987 to Rogers teaches a smoke generator which is mounted on the wing tips of an aircraft using the first method of sky writing. A smoke generating liquid, preferably covus oil is heated. The heated oil is subsequently delivered by a pump to smoke generating coils. In each coil the fluid is heated until it becomes a super-heated vapor, which escapes in the exhaust in the form of smoke. In Rogers patent there is only mention of smoke generated for sky writing (apart from air flow studies which are not relevant to the present invention). Sky writing is and has been using the sky as a background for writing on, nor is there any mention of cutting clouds.

U.S. Pat. No. 4,561,201 to Sanbom teaches a method for skywriting by dispensing fog from a winch line cable suspended from the aircraft controlled by solenoids hence providing a greater area covered by a single aircraft. Once again the sky is used as a background for writing nor is there any mention of cutting clouds.

U.S. Pat. No. 5,992,065 to Prieser teaches an aerial message system covering a much larger area by simultaneously using a master aircraft and slave aircraft working together. Short puffs of vapor are released by individual aircraft controlled by a computer in a master aircraft. Prieser's patent deals with sky writing once again and has shown a more advanced way of writing more simultaneously combined with a method for reducing risks to co-pilots, as they will be flying in a V formation and not in a line abreast formation. Once again the sky is used as a background for writing nor is there any mention of cutting clouds.

There is thus a widely recognized need for, and it would be highly advantageous to have, a cloud content presentation system devoid of the above limitations.

### SUMMARY OF THE INVENTION

According to one aspect of the present invention there is provided a method for creating an artificial cloud. The method includes the steps of providing a device for adding to the atmosphere at least one item selected from the group consisting of water vapor and particles and deploying at least one of the device at an elevation suitable for formation of the artificial cloud; and operating the device, such that the artificial cloud is formed.

According to another aspect of the present invention there is provided a system for creating an artificial cloud. The system includes a device for adding to the atmosphere at least one item selected from the group consisting of water vapor and particles. The system further includes a deployment mechanism capable of deploying at least one of the device at an elevation suitable for formation of the artificial cloud.

According to yet another aspect of the present invention there is provided a method for delivering a visual image. The method includes the step of projecting an image at a location selected from the group consisting of onto and within at least a portion of a cloud.

According to still another aspect of the present invention there is provided a method for delivering a visual image consisting of the step of dissipating at least a portion of a cloud, thereby creating the visual image.

According to still another aspect of the present invention there is provided a method for increasing navigational visibility, the method comprising the step of dissipating at least a portion of a cloud by irradiating said cloud with a laser.

According to further features in the described preferred embodiments the step of deploying includes deploying from an aircraft.

According to still further features in the described preferred embodiments the artificial cloud is selected from the group consisting of a low-density cloud, a medium-density cloud and a high-density cloud.

According to still further features in the described preferred embodiments wherein operation of the device includes addition of at least one coloring agent to the water vapor and particles, such that at least a portion of the artificial cloud is colored.

According to still further features in the described preferred embodiments wherein the artificial cloud is colored with at least one color.

According to still further features in the described preferred embodiments wherein projecting an image is accomplished using a device which includes a light source selected from the group consisting of laser visible light rays and non-laser visible light rays.

According to still further features in the described preferred embodiments the light source originates from a location selected from the group consisting an aircraft, a sea-going vessel, a motor vehicle and a land-based location.

According to still further features in the described preferred embodiments the cloud is selected from the group consisting of an artificial cloud and a natural cloud.

According to still further features in the described preferred embodiments the step of dissipating at least a portion of a cloud is affected by irradiating.

According to still further features in the described preferred embodiments irradiating is affected by a laser.

According to still further features in the described preferred embodiments the laser originates from a location selected from the group consisting of an aircraft, a sea going vessel, a motor vehicle and a land-based location.

The present invention successfully addresses the shortcomings of the presently known configurations by providing a system and method for advertising in the sky in addition to a method for cutting and clearing clouds.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow diagram illustrating steps in a method according to the present invention;

FIG. 2 is a schematic drawing of an aircraft creating an artificial cloud;

FIG. 3a is a schematic drawing of a method for delivering a visual image by projecting an image onto a high-density or medium-density cloud from an aircraft.

FIG. 3b is a schematic drawing of a method for delivering a visual image by projecting an image onto a low-density or invisible cloud from an aircraft.

FIG. 4 is a schematic drawing of a method for delivering a visual image consisting of the step of dissipating at least a portion of a cloud, using the cloud as a background by cutting the letters out of the cloud; and

FIG. 5 is a schematic drawing of a method for delivering a visual image consisting of the step of dissipating at least a portion of a cloud, by dissipating all of the cloud except for the image.

### DESCRIPTION OF THE PREFERRED EMBODIMENTS

The present invention is of a system and method for advertising and content presentation in the sky. Specifically, the present invention can be used to create an artificial cloud, which can be used as a background for delivering a visual image either by projecting an image onto the cloud or by cutting the cloud into the shape of the image.

The principles and operation of a system and method for advertising in the sky in addition to a method for cutting and clearing clouds according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the term “cloud” must be interpreted in its broadest possible sense. As such, it includes low-density clouds, which may be invisible or transparent to a person standing on the ground, medium density clouds, which are perceived as semi-opaque, and high-density clouds, which are perceived as opaque. Additionally, the term “cloud” includes haze, water vapor layer and cloud and alternately, clouds include water clouds, super cooled water clouds and ice clouds.

For purposes of this specification and the accompanying claims, the term “dissipating” must be interpreted in its broadest possible sense. As such, cloud dissipation includes, but is not limited to, heating of the water droplets by direct absorption of radiation. Such radiation may be, for example, in the microwave or infrared region (e.g. from a laser). Further included in this definition is heating of the air by conventional heating methods (e.g. hot wire filaments and fans such as those commonly employed to clear ground fogs). This definition further includes, converting super cooled water clouds into ice clouds, thus decreasing the optical density of the cloud and inducing removal of the water by falling ice particles. One ordinarily skilled in the art will be capable of using dry ice, silver iodide or other ice nuclei to accomplish this purpose.

A non-limiting example of creating a cloud according to one embodiment of the present invention is described herein below.

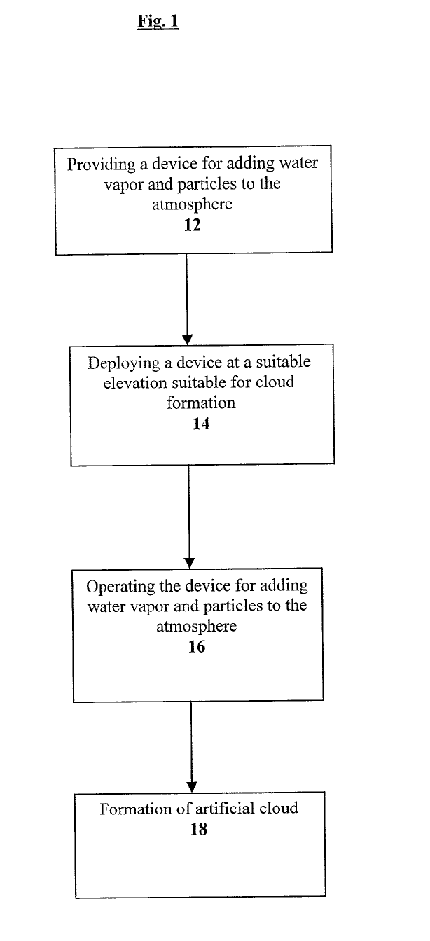

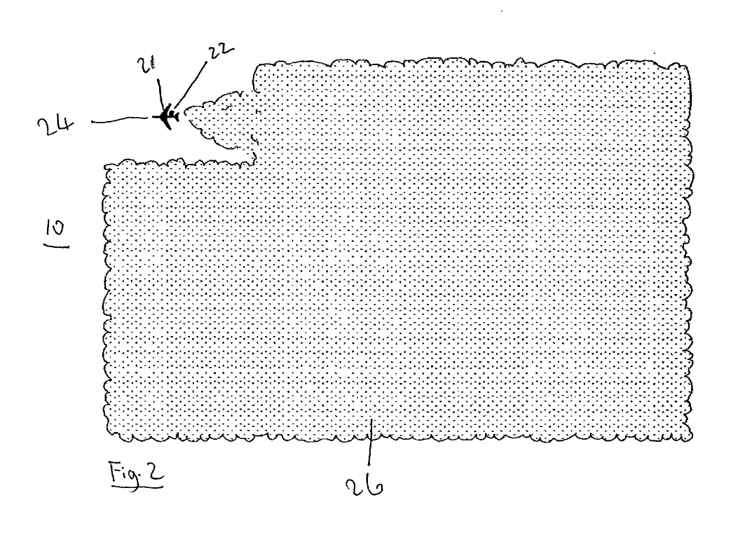

Referring now to the drawings, FIG. 1 illustrates the method for creating an artificial cloud 26. The method includes the step 12 of providing a device 22 for adding to the atmosphere at least one item selected from the group consisting of water vapor and particles. Typically, the deployment vehicle for delivery of water vapor and particles is an aircraft 24 (FIG. 2). Aircraft 24 delivery of water vapor and particles is common practice and is known to those ordinarily skilled in the art of skywriting.

The method further includes deploying 14 at least one of the devices 22 at an elevation suitable for cloud formation and then operating 16—the device, such that a cloud forms 18. Particles and water vapor are added to the atmosphere according to need each time aircraft 24 is deployed. If the atmosphere lacks sufficient particles for formation of an artificial cloud, a sufficient quantity of particles is added. Similarly if there is not sufficient water vapor in the atmosphere the device 22 is capable of adding water vapor to the atmosphere.

In skywriting, as taught in the prior art, a number of lines are created to form a message by at least one aircraft. According to the present invention, a large cloud 26 is created. According to some embodiments of the present invention, cloud 26 serves as a base or a background for projecting an image 40 or for cutting as will be described below.

In an alternate embodiment coloring agents are added to the water vapor and/or particles deployed from device 22. This enables the creation of colored clouds 26. Alternately adding and ceasing to add colorant can create a multi-color cloud 26. FIG. 2 is a schematic representation of a system 10 for creating an artificial cloud. System 10 includes a device 22 for adding to the atmosphere at least one item selected from the group consisting of water vapor and particles. System 10 further includes a deployment mechanism 21 capable of deploying at least one of the devices 22 at an elevation suitable for cloud formation. Preferably, deployment mechanism 21 includes aircraft 24 although other deployment mechanisms 20 are within the scope of the present invention. For example device 22 could be located at a high elevation, such as a mountain, which is in close proximity to the designated place that cloud 26 is to be formed. Many large cities are close to high mountains such as Rio de Janeiro.

Coloring agents are added to the water vapor and particles as needed to proved a colored appearance in the artificial cloud 26. Coloring clouds is common and known to one ordinarily skilled in the art of skywriting.

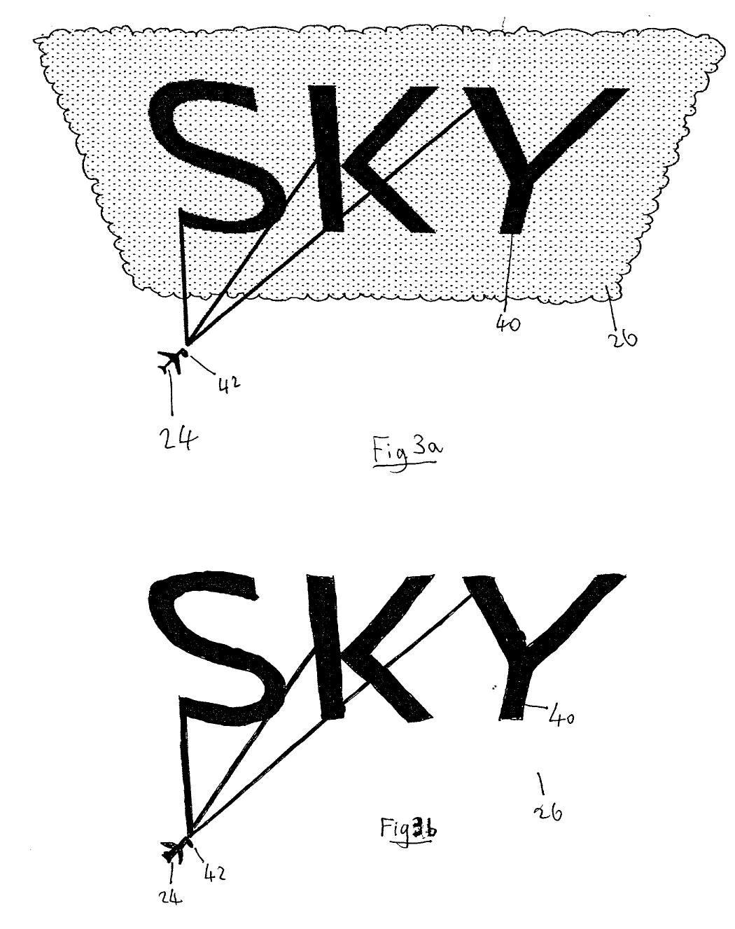

The present invention is further embodied by a method (FIGS. 3a and 3b) for delivering a visual image consisting of the step of projecting an image 40 at a location selected from the group consisting of onto and within at least a portion of a cloud 26. Cloud 26 is either an artificial cloud created as described hereinabove, or an existing cloud in the sky. A light source 42 projects image 40 onto the cloud by using a visible light source, for example a laser beam. Image 40 is preferably projected from aircraft 24. Alternately, or additionally, image 40, may be projected from a sea-going vessel, a motor vehicle or a land-based location. Light source 42 can be projected onto a high-density cloud or a medium-density cloud as illustrated in FIG. 3a or onto a low-density or invisible cloud as illustrated in FIG. 3b.

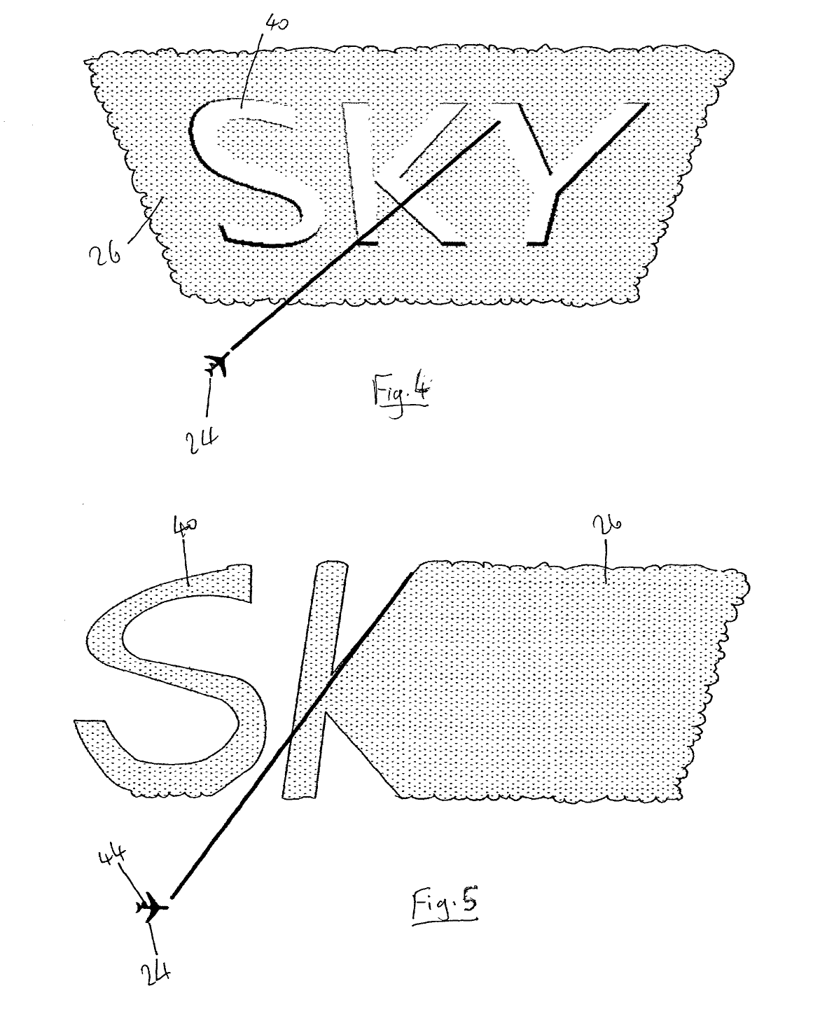

The present invention is further embodied by a method (FIGS. 4 and 5) for delivering a visual image 40 consisting of the step of dissipating at least a portion of a cloud 26, thereby creating visual image 40. Dissipating at least a portion of a cloud 26 is affected by irradiating cloud 26.

A preferred radiation source 44 for accomplishing the desired dissipating effect is a laser source.

FIG. 4 illustrates one preferred embodiment of a method for delivering a visual image 40 consisting of the step of dissipating at least a portion of a cloud 26, using the cloud as a background by cutting, for example, letters out of cloud 26; and FIG. 5 is a schematic drawing of an alternate embodiment of a method for delivering a visual image 40 consisting of the step of dissipating at least a portion of a cloud 26, by dissipating all of the cloud except for the image.

Dissipating at least parts of clouds is preferably performed from an aircraft 24. Alternately, or additionally, dissipating may be accomplished from a sea-going vessel, a motor vehicle or a land-based location. The technology of dissipating water vapor is common to those skilled in the art of laser technology. An image such as a logo can be shaped from a cloud either as a two-dimensional image or as a three-dimensional image.

The present invention is further embodied by a method for increasing navigational visibility. The method includes the step of dissipating at least a portion of a cloud with a laser as described above, however the object of this embodiment is to clear cloud cover in order to obtain increased navigational visibility as illustrated in FIGS. 4 and 5.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

An illustrative, non-limiting, example of one embodiment of the present invention is a sign in the sky high enough and large enough to be seen within a radius of 20 to 30 km by any observer that will look up to the sky in the direction of the sign. The sign will be strong enough to be viewed during day or night from the ground. It will remain lighted as long as illuminated by laser irradiation.

The size of the sign could for example be in the order of at least one square kilometer and it will preferably be at any altitude for example from 5,000 feet to 60,000 feet. In order to avoid problem of safety by the ground observers laser irradiation could originate from a location lower than altitude of the sign. In order avoid problems with pilots and other possible flying observers the laser may be placed onboard an aircraft at an altitude of, for example, 35,000 to 45,000 feet, which is above commercial aviation altitudes or at any other suitable altitude. The illuminating aircraft will carry a 100-200 watt laser system capable of illuminating with two or three colors. The illumination shapes will be done using a commercially available device familiar to those ordinarily skilled in the art. One example of such a device is the DLP (Texas Instruments Incorporated, 12500 TI Boulevard, Dallas, Tex. 75243-4136). This device allows writing the whole sign at once. It holds 250,000 mirrors each illuminating a single picture element (pixel) in the sky. The DLP with the laser is mounted on a pan and tilt gimbals isolate them from the platform movements and disturbances and to cover larger areas of the image formed. The platform can have a data link with a ground station to allow controlling of the platform and the skywriting system or can be totally controlled internally in the aircraft. This configuration requires two operators, one that managing the skywriting system and the mission as a whole and one that flies the platform. The advertisement will be seen almost instantly in the sky in several colors and for relatively long period with the same resolution as it was written. In contrast to prior art skywriting, the illuminated clouds of the present invention offer greater persistence and less loss of image sharpness as the cloud disperses by diffusion.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for creating an artificial cloud, the method comprising the steps of:
(a) providing a device for adding to the atmosphere at least one item selected from the group consisting of water vapor and particles;
(b) deploying at least one of said device at an elevation suitable for formation of the artificial cloud; and
(c) operating said device, such that the artificial cloud is formed.

2. The method of claim 1, wherein said step of deploying includes deploying from an aircraft.

3. The method of claim 1, wherein the artificial cloud is selected from the group consisting of a low-density cloud, a medium-density cloud and a high-density cloud.

4. The method of claim 1, wherein operation of said device includes addition of at least one coloring agent to said water vapor and particles, such that at least a portion of the artificial cloud is colored.

5. A system for creating an artificial cloud, the system comprising:
(a) a device for adding to the atmosphere at least one item selected from the group consisting of water vapor and particles;
(b) a deployment mechanism capable of deploying at least one of said device at an elevation suitable for formation of the artificial cloud.

6. The system of claim 5, wherein said deployment mechanism includes an aircraft.

7. The system of claim 5, wherein the artificial cloud is selected from the group consisting of a low-density cloud, a medium-density cloud and a high-density cloud.

8. The system of claim 5 wherein the artificial cloud is colored with at least one color.

9. A method for delivering a visual image consisting of the step of projecting an image at a location selected from the group consisting of onto and within at least a portion of a cloud.

10. The method of claim 9, wherein the step of projecting an image is affected by using a device which includes a light source selected from the group consisting of laser visible light rays and non-laser visible light rays.

11. The method of claim 10, wherein said light source originates from a location selected from the group consisting an aircraft, a sea-going vessel, a motor vehicle and a land-based location.

12. The method of claim 9, wherein the cloud is selected from the group consisting of an artificial cloud and a natural cloud.

13. A method for delivering a visual image consisting of the step of dissipating at least a portion of a cloud, thereby creating the visual image.

14. The method of claim 13, wherein said step of dissipating at least a portion of a cloud is affected by irradiating.

15. The method of claim 14, wherein said irradiating is affected by a laser.

16. The method of claim 13, wherein the cloud is selected from the group consisting of an artificial cloud and a natural cloud.

17. A method for increasing navigational visibility, the method comprising the step of dissipating at least a portion of a cloud by irradiating said cloud with a laser.

18. The method of claim 16, wherein said laser originates from a location selected from the group consisting of an aircraft, a sea going vessel, a motor vehicle and a land-based location.
